(19) United States
(12) Patent Application Publication
(10) Pub. No.: US 2022/0358720 A1
(43) Pub. Date: Nov. 10, 2022

(54) METHOD AND APPARATUS FOR GENERATING THREE-DIMENSIONAL CONTENT

(71) Applicant: ELECTRONICS AND TELECOMMUNICATIONS RESEARCH INSTITUTE, Daejeon (KR)

(72) Inventors: Jae Hean KIM, Daejeon (KR); Bonki KOO, Daejeon (KR)

(73) Assignee: ELECTRONICS AND TELECOMMUNICATIONS RESEARCH INSTITUTE, Daejeon (KR)

(21) Appl. No.: 17/545,476

(22) Filed: Dec. 8, 2021

(30) Foreign Application Priority Data
May 6, 2021 (KR) 10-2021-0058372

(51) Int. Cl. G06T 17/20; G06T 7/90; G06T 15/04; G06T 19/20

(52) U.S. Cl. CPC G06T 17/20; G06T 7/90; G06T 15/04; G06T 19/20; G06T 2219/2016; G06T 2207/30196

(57) ABSTRACT

A method for generating three-dimensional (3D) content for a performance of a performer in an apparatus for generating 3D content is provided. The apparatus for generating 3D content obtains a 3D appearance model and texture information of the performer using the images of the performer located in the space, sets a plurality of nodes in the 3D appearance model of the performer, generates a 3D elastic model of the performer using the texture information, obtains a plurality of first images of the performance scene of the performer photographed by a plurality of first cameras installed in a performance hall, renders a plurality of virtual images obtained by photographing a 3D appearance model according to position change of each node in a 3D elastic model of the performer through a plurality of first virtual cameras having the same intrinsic and extrinsic parameters as the plurality of first cameras, using the texture information, determines an optimal position of each node by using color differences between the plurality of first images and a plurality of first rendered with respect to the plurality of virtual images obtained by the plurality of first virtual cameras, and generates a mesh model describing the performance scene by applying 3D elastic model parameter values corresponding to the optimal position of each node to the 3D elastic model.

### CROSS-REFERENCE TO RELATED APPLICATION

This application claims priority to and the benefit of Korean Patent Application No. 10-2021-0058372 filed in the Korean Intellectual Property Office on May 6, 2021, the entire contents of which are incorporated herein by reference.

### BACKGROUND

### (a) Field

The present invention relates to a method and apparatus for generating three-dimensional content. More particularly, the present invention relates to a method and apparatus for generating three-dimensional content that can obtain three-dimensional information about a performance of the performer using a camera without interfering with the performer's activities.

### (b) Description of Related Art

In order to obtain augmented reality three-dimensional (3D) information about the performance of the performer, various sensors arranged around the object are used. These types of sensors are divided into active sensors and passive sensors. The active sensor irradiates a specific pattern of visible light or a laser to the 3D information acquisition target, checks the pattern change of the reflected light, and acquires the 3D shape of the target. This method includes a method using one image and a method using multiple images. The method of using one image has a limit in precision because it has to add a code for recognition in one pattern. The method of using multiple images has an advantage in precision because it has to add the code for recognition in multiple patterns, but since the method of using multiple images has to irradiate multiple patterns in one scene and photograph them, it is impossible to obtain three-dimensional information of a moving object during this period. On the other hand, a passive sensor can acquire a 3D shape only by acquiring an image without irradiating light, but it is necessary to have textures that can be distinguished from different surface areas on the surface of the target object. Depending on the sharpness or presence of these textures, precision is affected and missing sections may occur.

The conventional method of acquiring 3D information about a performance uses passive sensors in consideration of high-level precision and dynamic characteristics. However, in the conventional method, although the resolution of the image captured by the camera is high, the quality of the obtained 3D content is insufficient for commercialization. This is because the conventional method performs 3D reconstruction from pixel information of an image by trigonometry. In the case of arranging cameras around the performance hall in order to secure sufficient space for the performance, the resolution of the space by the number of camera pixels decreases inversely proportionally to the square of the distance.

On the other hand, there is also a method of reconstructing the user's appearance to a high-quality model in advance, and matching the model to the motion information by acquiring only motion information in the field, in order to obtain 3D information about the performance. However, if the performer is dressed in a costume for image-based motion capture and a marker is attached to perform the task, the performer is forcing an environment that is different from that of the actual performance, so it is not an appropriate approach. Moreover, in this method, it is difficult to obtain dynamic motions such as of costumes other than the performer's body parts.

Therefore, there is a need to develop a method for acquiring high-quality performance content without interfering with the performer's performance activities.

### SUMMARY

The present invention has been made in an effort to provide to a method and apparatus for generating three-dimensional content capable of acquiring high-quality 3D information about a performance without interfering with the performance activities.

According to an embodiment, a method for generating three-dimensional (3D) content for a performance of a performer in an apparatus for generating 3D content is provided. The method for generating 3D content includes: obtaining a 3D appearance model and texture information of the performer using images of the performer located in the space; setting a plurality of nodes in the 3D appearance model of the performer; generating a 3D elastic model of the performer using the texture information; obtaining a plurality of first images of the performance scene of the performer photographed by a plurality of first cameras installed in a performance hall; rendering a plurality of virtual images obtained by photographing a 3D appearance model according to position change of each node in a 3D elastic model of the performer through a plurality of first virtual cameras having the same intrinsic and extrinsic parameters as the plurality of first cameras, using the texture information; determining an optimal position of each node by using color differences between the plurality of first images and the plurality of first rendered images obtained by the plurality of first virtual cameras; and generating a mesh model describing the performance scene by applying 3D elastic model parameter values corresponding to the optimal position of each node to the 3D elastic model.

The determining may include: calculating values of a first cost function in consideration of the color differences between the plurality of first images and the plurality of first rendered images while changing the 3D elastic model parameter values related to the position change of each node in the 3D elastic model; and determining 3D elastic model parameter values of each node at which the value of the first cost function is minimized.

The 3D elastic model parameter values related to the position change of each node may include translational and rotational parameters of each node.

The generating of a 3D elastic model may include: obtaining a plurality of second images of continuous motion postures of the performer photographed by a plurality of second cameras installed in the space; rendering a plurality of virtual images obtained by photographing the 3D appearance model according to the change of the 3D elastic model parameter values required for generating the 3D elastic model of the performer through a plurality of second virtual cameras having the same intrinsic and extrinsic parameters as the plurality of second cameras, using the texture information; and determining the 3D elastic model parameter values by using a second cost function in consideration of color differences between the plurality of second images and the plurality of second rendered images obtained by the plurality of second virtual cameras.

The determining of the 3D elastic model parameter values may include: calculating values of the second cost function while changing the 3D elastic model parameter values; and determining the 3D elastic model parameter values at which the value of the second cost function is minimized.

The 3D elastic model parameter values may include a geodesic neighbor distance of each node, an elastic coefficient between each node and nodes within a geodesic neighbor distance of each node, parameters related to the position change of each node, and a physical property coefficient indicating the effect of the position change of each node on the change of each mesh vertex of the 3D appearance model.

The obtaining of a 3D appearance model and texture information may include generating the 3D appearance model of the performer and the texture information by using a plurality of images of the performer taking a fixed motion posture photographed by a plurality of second cameras installed in the space.

The obtaining of a 3D appearance model and texture information may include generating the 3D appearance model and texture information of the performer through close-up photography of the performer using the plurality of second cameras in the space.

According to another embodiment, an apparatus for generating three-dimensional (3D) content for a performance of a performer is provided. The apparatus for generating 3D content includes a 3D appearance model generator, a 3D elastic model generator, an image obtainer, a virtual image generator, and a 3D information generator. The 3D appearance model generator generates a 3D appearance model and texture information using images of a performer located in a space. The 3D elastic model generator sets a plurality of nodes in the 3D appearance model and determines 3D elastic model parameter values for the plurality of nodes to generate a 3D elastic model of the performer. The image obtainer obtains a plurality of first images of the actual performance scene of the performer photographed by a plurality of first cameras installed in a performance hall. The virtual image generator renders a plurality of virtual images obtained by photographing a 3D appearance model according to a change of 3D elastic model parameter values related to the position change among the 3D elastic model parameter values through a plurality of first virtual cameras having the same intrinsic and extrinsic parameters as the plurality of first cameras, using the texture information. The 3D information generator determines an optimal position of each node by using color differences between the plurality of first images and the plurality of first rendered images obtained by the plurality of first virtual cameras.

The 3D information generator may generate a mesh model describing the performance scene of the performer by applying the 3D elastic model parameter values corresponding to the optimal position of each node to the 3D elastic model of the performer.

The 3D information generator may calculate values of a first cost function in consideration of the color differences between the plurality of first images and the plurality of first rendered images while changing the 3D elastic model parameter values related to the position change of each node in the 3D elastic model, and may determine 3D elastic model parameter values of each node at which the value of the first cost function is minimized.

The image obtainer may obtain a plurality of second images of continuous motion postures of the performer photographed by a plurality of second cameras installed in the space, the virtual image generator may render a plurality of virtual images obtained by photographing the 3D appearance model according to the change of the 3D elastic model parameter values through a plurality of second virtual cameras having the same intrinsic and extrinsic parameters as the plurality of second cameras, using the texture information, and the 3D elastic model generator may determine the 3D elastic model parameter values by using a second cost function in consideration of color differences between the plurality of second images and the plurality of second rendered images obtained by the plurality of second virtual cameras.

The 3D elastic model generator may calculate values of the second cost function while changing the 3D elastic model parameter values, and may determine the 3D elastic model parameter values at which the value of the second cost function is minimized.

The 3D elastic model parameter values may include a geodesic neighbor distance of each node, an elastic coefficient between each node and nodes within a geodesic neighbor distance of each node, parameters related to the position change of each node, and a physical property coefficient indicating the effect of the position change of each node on the change of each mesh vertex of the 3D appearance model.

The virtual image generator may use the remaining values excluding values related to the position change among the 3D elastic model parameter values as it is, when performing the actual performance by the performer.

The values related to the position change among the 3D elastic model parameter values may include translational and rotational parameters of each node.

The image obtainer may generate the 3D appearance model and texture information of the performer through close-up photography of the performer using the plurality of second cameras in the space.

### BRIEF DESCRIPTION OF DRAWINGS

FIG. 1 is a flowchart illustrating a method for generating 3D content according to an embodiment.

FIG. 2 is a diagram illustrating an example of a method for obtaining a 3D appearance model of a performer according to an embodiment.

FIG. 3 is a diagram illustrating a 3D elastic model parameter required when generating a 3D elastic model of a performer according to an embodiment.

FIG. 4 is a conceptual diagram illustrating a method for determining a 3D elastic model parameter required for generating a 3D elastic model according to an embodiment.

FIG. 5 is a flowchart illustrating a method for determining a 3D elastic model parameter required for generating a 3D elastic model according to an embodiment.

FIG. 6 is a conceptual diagram illustrating a method for obtaining 3D information of a performer when performing using a 3D elastic model according to an embodiment.

FIG. 7 is a flowchart illustrating a method for obtaining 3D information of a performer when performing using a 3D elastic model according to an embodiment.

FIG. 8 is a diagram illustrating an apparatus for generating 3D content according to an embodiment.

FIG. 9 is a diagram illustrating an apparatus for generating 3D content according to another embodiment.

### DETAILED DESCRIPTION

Hereinafter, embodiments will be described in detail with reference to the attached drawings so that a person of ordinary skill in the art may easily implement the present invention. The present invention may be modified in various ways, and is not limited thereto. In the drawings, elements that are irrelevant to the description are omitted for clarity of explanation, and like reference numerals designate like elements throughout the specification.

Throughout the specification and claims, when a part is referred to “include” a certain element, it means that it may further include other elements rather than exclude other elements, unless specifically indicated otherwise.

Now, a method and apparatus for generating 3D content according to an embodiment will be described in detail with reference to the drawings.

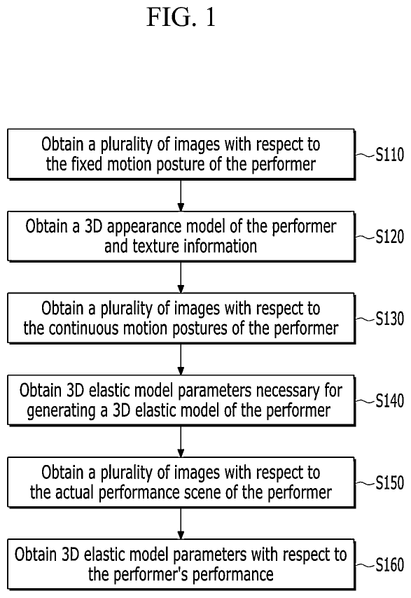

FIG. 1 is a flowchart illustrating a method for generating 3D content according to an embodiment.

Referring to FIG. 1, the apparatus for generating 3D content obtains a plurality of images photographed by a plurality of cameras installed at different positions with respect to the fixed motion posture of the performer (S110), and obtains a 3D appearance model of the performer and texture information based on the obtained plurality of image information (S120).

The apparatus for generating 3D content obtains a plurality of images photographed by the plurality of cameras with respect to the continuous motion postures of the performer (S130), and obtains 3D elastic model parameters necessary for generating a 3D elastic model of the performer using the 3D appearance model based on the obtained plurality of image information (S140).

The generation of the 3D appearance model and the 3D elastic model of the performer is performed individually for each performer. Therefore, close-up photography is possible because a large space is not required to photograph the performer, and a high-quality image, a high-quality 3D appearance model, and a 3D elastic model can be generated through such close-up photography.

Next, when the performer performs an actual performance in the performance hall, the apparatus for generating 3D content obtains a plurality of images with respect to the performance scene of the performer photographed with the plurality of cameras (S150), and obtains 3D elastic model parameters with respect to the performer's performance using the generated 3D elastic model based on a plurality of pieces of image information on the obtained performance scene (S160).

If the 3D elastic model parameters with respect to a performance scene of each performer are obtained, it is possible to generate 3D content for the performance by using the 3D elastic model parameters with respect to the performance scene.

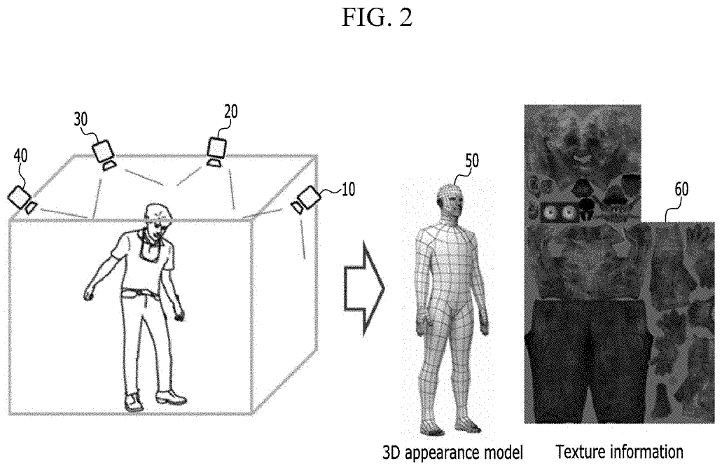

FIG. 2 is a diagram illustrating an example of a method for obtaining a 3D appearance model of a performer according to an embodiment.

Referring to FIG. 2, when the performer 1 in a predetermined space stands in place and takes a fixed motion posture, a plurality of cameras 10, 20, 30, and 40 installed at different positions in the space photograph the performer 1.

The apparatus for generating 3D content obtains images photographed from the plurality of cameras 10, 20, 30, and 40, and obtains a 3D appearance model 50 of the performer and texture information 60 using the obtained images photographed from the plurality of cameras 10, 20, 30, and 40.

The 3D appearance model 50 may be generated in a mesh structure and may include texture information 60. The 3D appearance model 50 may be obtained using various methods.

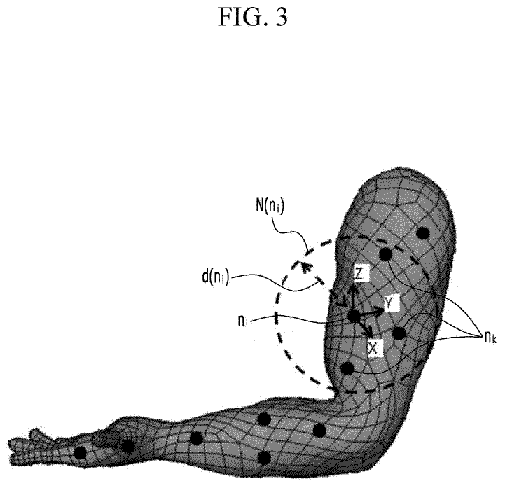

FIG. 3 is a diagram illustrating a 3D elastic model parameter required when generating a 3D elastic model of a performer according to an embodiment. In FIG. 3, only the arm portion of the 3D appearance model is shown for convenience of explanation.

Referring to FIG. 3, the apparatus for generating 3D content uniformly sets nodes in the 3D appearance model. Hereinafter, description will be made based on one node nᵢ among the nodes, and the same may be applied to other nodes.

The apparatus for generating 3D content allocates a geodesic neighbor distance d(nᵢ) to the node nᵢ, and sets the nodes nₖ within the neighbor distance d(n) as the neighbor set N(nᵢ) of the node nᵢ.

The apparatus for generating 3D content allocates an elastic coefficient wᵢₖ to each node pair between the node nᵢ and each node nₖ belonging to the neighbor set N(nᵢ).

The apparatus for generating 3D content allocates a rotational parameter Rᵢ and a translational parameter tᵢ to the node nᵢ.

How the 3D elastic model changes according to the change in the translational parameter tᵢ of the 3D elastic model is as follows.

First, assuming that the desired final position of a specific node nᵢ is δᵢ, the movement cost fᵢ of the node nᵢ is defined as in Equation 1.

fᵢ=∥tᵢ−δᵢ∥² (Equation 1)

Also, by setting the mutual influence relationship between nodes, the elastic effect can be embodied.

If the positions of the node nᵢ and the node nₖ are set to tᵢ and tₖ, respectively, the movement cost Cᵢₖ allocated to the node pair between the node nᵢ and each node nₖ belonging to the neighbor set N(nᵢ) can be expressed as in Equation 2.

cᵢₖ=wᵢₖ∥Rᵢ(nₖ−nᵢ)+nᵢ+tᵢ−(nₖ+tₖ)∥² (Equation 2)

In this case, a translational parameter tᵢ and a rotational parameter Rᵢ indicating a position change of the node nᵢ in a direction in which the cost function defined in Equation 3 is minimized are calculated.

$$E = {{\sum }_{i = 1}}^{N} {\sum }_{k ∈ N ( {n}_{i} )} {c}_{ik} + {{\sum }_{i = 1}}^{N} {f}_{i} \qquad ( Equation 3 )$$

Here, N is the total number of nodes.

At this time, according to the rigid body transformation of the nodes, a new position vⱼ′ of the mesh vertex vⱼ of the 3D appearance model is determined as in Equation 4.

$${v}_{j}^{′} = {{\sum }_{i = 1}}^{N} {λ}_{ji} [ {R}_{i} ( {v}_{j} - {n}_{i} ) + {n}_{i} + {t}_{i} ] \qquad ( Equation 4 )$$

In Equation 4, λⱼᵢ represents a physical property coefficient. The physical property coefficient represents a weight that determines how much the position change of the node nᵢ affects the change in the vertex vⱼ of the mesh.

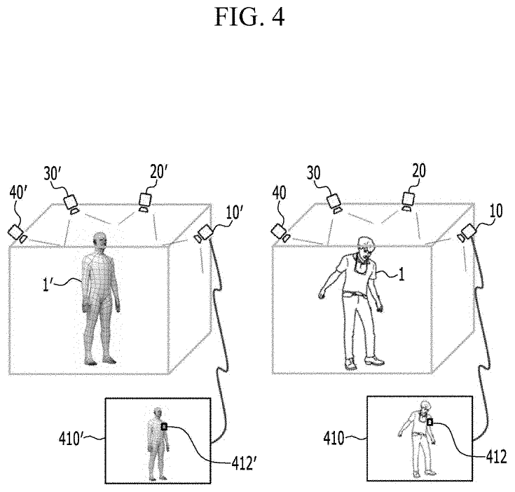

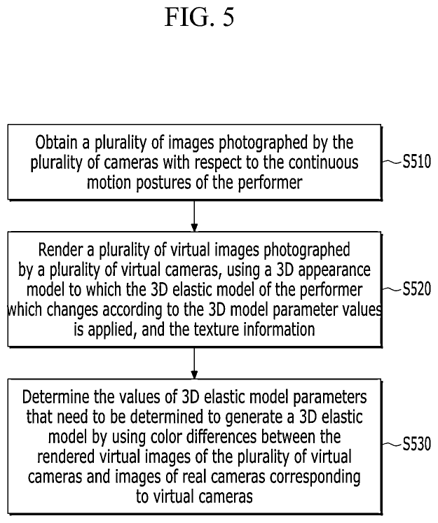

FIG. 4 is a conceptual diagram illustrating a method for determining a 3D elastic model parameter required for generating a 3D elastic model according to an embodiment, and FIG. 5 is a flowchart illustrating a method for determining a 3D elastic model parameter required for generating a 3D elastic model according to an embodiment.

Referring to FIG. 4 and FIG. 5, the performer 1 takes a continuous motion posture, and a plurality of cameras 10, 20, 30, and 40 photograph the performer 1.

The apparatus for generating 3D content obtains a plurality of images photographed by the plurality of cameras 10, 20, 30, and 40 with respect to the continuous motion postures of the performer (S510). The apparatus for generating 3D content uses the plurality of images photographed by the plurality of cameras 10, 20, 30, and 40 to generate a 3D elastic model.

The 3D elastic model parameters that need to be determined for generating the 3D elastic model are the geodesic neighborhood distances for all nodes, the elastic coefficients between each node and each node belonging to the geodesic neighborhood distances of each node, the rotational parameter and the translational parameter related to the position change of each node, and the physical property coefficient between each node and each mesh vertex indicating the effect of the position change of each node on the change of each mesh vertex of the 3D appearance model. The shape of the 3D elastic model of the performer changes according to the change of the 3D elastic model parameter values.

The apparatus for generating 3D content renders a plurality of virtual images photographed by a plurality of virtual cameras 10′, 20′, 30′, and 40′ using a 3D appearance model to which the 3D elastic model of the performer which changes according to the 3D model parameter values is applied, and the texture information obtained in the previous step (S120 in FIG. 1) (S520). At this time, the plurality of virtual cameras 10′, 20′, 30′, and 40′ correspond to the real cameras 10, 20, 30, and 40 for photographing the performers, respectively, and intrinsic and extrinsic parameters of the plurality of virtual cameras 10′, 20′, 30′, and 40′ are set to be same as the intrinsic and extrinsic parameters of the corresponding real cameras 10, 20, 30, and 40. Accordingly, the virtual image of each virtual camera 10′, 20′, 30′, and 40′ corresponds to the image of the corresponding real camera 10, 20, 30, and 40.

The apparatus for generating 3D content determines the values of 3D elastic model parameters that need to be determined to generate a 3D elastic model by using color differences between rendered virtual images of each virtual camera 10′, 20′, 30′, and 40′ and images of a real camera corresponding to each virtual camera 10, 20, 30, and 40 (S530).

For example, if the intrinsic and extrinsic parameters of the virtual cameras 10′, 20′, 30′, and 40′ are the same as the intrinsic and extrinsic parameters of the real cameras 10, 20, 30, 40, and the illumination parameter and the 3D appearance are perfect, the rendered image 410′ in which the texture is reflected from the image of the virtual camera (e.g., 10′) photographing the 3D appearance model 1′ of the performer according to the change of the parameters of the 3D elastic model and the image 410 of the real camera (e.g., 10) photographing the performer 1 and the performer 1 will match. In FIG. 4, only one image 410 photographed by one camera 10 and an image 410′ rendered from an image of a virtual camera 10′ corresponding thereto are shown for convenience of explanation.

Accordingly, the apparatus for generating 3D content determines 3D elastic model parameters using a cost function that considers the color difference between an image rendered from an image of each virtual camera 10′, 20′, 30′, and 40′ and an image of each real camera 10, 20, 30, and 40 corresponding to each virtual camera 10′, 20′, 30′, and 40′. A cost function in consideration of the color difference between the two images may be set as in Equation 5.

$${{\sum }_{t = 1}}^{T} {{\sum }_{c = 1}}^{M} {\sum }_{p ∈ B ( t , c )} {‖ {I}_{cp} ( t ) - {π}_{cp} ( D , W , {Δ}_{t} , Λ ) ‖}^{2} \qquad ( Equation 5 )$$

Here, D={d(nᵢ)|i=1, . . . , N}, W={Wᵢₖ|i=1, . . . , N, k=1, . . . , N}, Δt={δᵢₜ|i=1, . . . , N}, ∧={λⱼᵢ|i=1, . . . , N, j=1, . . . , V}, V is the total number of mesh vertices, T is the total number of photographs, and M is the number of cameras that photograph the 3D appearance model 1′ or the performer 1 to which the three-dimensional elastic model is applied. B(t,c) is the set of pixels p occupied by the performer in the image 410 of the real camera c at time t. l_{cp}(t) represents the color 412 of a pixel p in the image 410 of the real camera c at time t. π_{cp} denotes the color 412′ of the pixel p in the rendered image 410′ from the image of the virtual camera c′ photographing the 3D appearance model 1′ according to the change of the parameter of the 3D elastic model. The virtual camera c′ is set to have the same intrinsic and extrinsic parameters as the real camera c. δᵢₜ represents the final position δᵢ of the node nᵢ at time t. Here, it is assumed that the illumination state and each camera used for photographing are calibrated, and the intrinsic and extrinsic parameters of the real camera c and the virtual camera c′ are set to be the same.

The apparatus for generating 3D content determines the 3D elasticity model parameters such that the value of the cost function shown in Equation 5 is minimized. That is, the apparatus for generating 3D content may determine the geodesic neighbor distance d(n) for the node nᵢ, the elastic coefficients Wᵢₖ between the node nᵢ and each node nₖ belonging to the neighborhood set N(nᵢ), the rotational parameter Rᵢ and the translational parameter tᵢ related to the position change of the node nᵢ, the final position δᵢₜ of the node nᵢ, and the physical property coefficient λⱼᵢ indicating the effect of the position change of the node nᵢ on the change of each mesh vertex vⱼ of the 3D appearance model.

The apparatus for generating 3D content finds optimal parameter values while changing the values of the 3D elastic model parameters d(nᵢ), Wᵢₖ, (Rᵢ, tᵢ), δᵢₜ, and λⱼᵢ until the value of the cost function shown in Equation 5 is the minimum value. Through this optimization, the 3D elastic model parameters d(nᵢ), Wᵢₖ, (Rᵢ, tᵢ), δᵢₜ, and λⱼᵢ are determined.

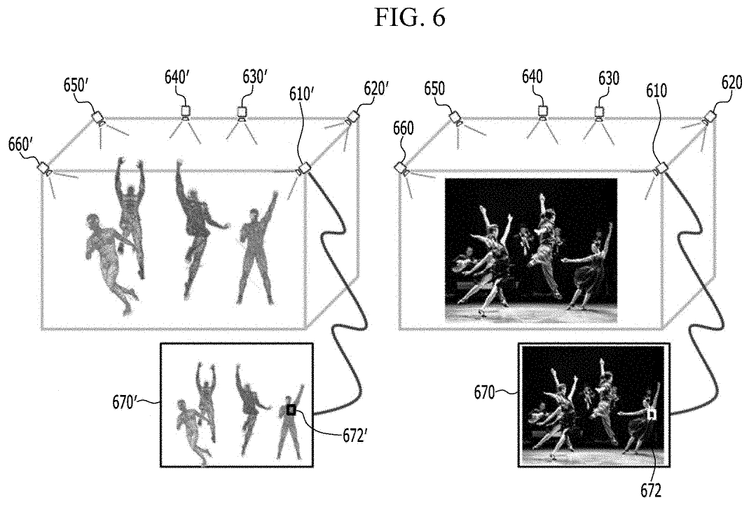

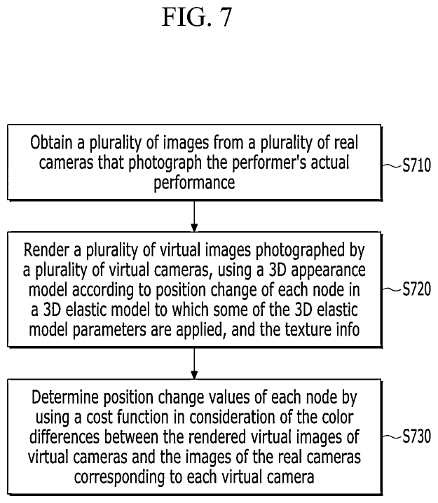

The 3D elastic model of the performer is generated through the determined 3D elastic model parameters d(nᵢ), Wᵢₖ, (Rᵢ, tᵢ), δᵢₜ, and λⱼᵢ. Here, Δt and position change parameters Rᵢ and tᵢ are motion information of node nᵢ obtained in the process of obtaining the 3D elastic model, and thus are additional parameters not related to the motion during actual performance. Therefore, the apparatus for generating 3D content uses the same parameters d(nᵢ), Wᵢₖ, and λⱼᵢ among the 3D elastic model parameters obtained through the process described above, and should determine the elastic model parameters (Rᵢ, tᵢ) and δᵢₜ expressing the motion information of nodes according to the actual performance of the performer, during the actual performance. A method of determining parameters (Rᵢ, tᵢ), and δᵢₜ during the actual performance of a performer will now be described with reference to FIGS. 6 and 7.

FIG. 6 is a conceptual diagram illustrating a method for obtaining 3D information of a performer when performing using a 3D elastic model according to an embodiment, and FIG. 7 is a flowchart illustrating a method for obtaining 3D information of a performer when performing using a 3D elastic model according to an embodiment.

Referring to FIGS. 6 and 7, when a performer performs an actual performance, the apparatus for generating 3D content obtains a plurality of images from a plurality of real cameras 610 to 660 that photograph the performer's actual performance (S710).

The apparatus for generating 3D content renders a plurality of virtual images photographed by a plurality of virtual cameras 610′ to 660′ using a 3D appearance model according to position change of each node in a 3D elastic model to which the 3D elastic model parameters d(nᵢ), Wᵢₖ, and λⱼᵢ determined for each node for the performer are applied and the texture information obtained in previous step (S120 in FIG. 1) (S720).

The apparatus for generating 3D content determines position change values of each node by using a cost function in consideration of the color differences between the rendered images to which the textures are applied to the virtual image of each virtual camera 610′ to 660′ and the images of the real cameras 610 to 660 corresponding to each virtual camera 610′ to 660′ (S730). Since only motion information of each performer needs to be determined during an actual performance, the cost function for determining the position change values of each node may be set as shown in Equation 6.

$${{\sum }_{t = 1}}^{T} {{\sum }_{c = 1}}^{L} {\sum }_{p ∈ B ( c )} {‖ {I}_{cp} ( t ) - {π}_{cp} ( {Δ}_{t} ) ‖}^{2} \qquad ( Equation 6 )$$

Here, Δt={δᵢₜ|i=1, . . . , N}, and B(c) is a set of pixels p occupied by the performer in the image 670 of the real camera c 610. lcp(t) represents the color 672 of pixel p in image 670 of the real camera c (e.g., 610) at time t. πcp represents the color 672′ of the pixel p in the rendered image 670′ from the image of the virtual camera c′ (e.g., 610′) photographing the 3D appearance model according to the change of the 3D elastic model parameter δᵢₜ. L is the number of cameras used in the actual performance.

Similarly to Equation 5, the value of the cost function shown in Equation 6 also decreases as the rendered images from the image of the virtual cameras 610′ to 660′ and the images of the real cameras 610 to 660 which photographed the actual performance scene of the performer match.

In the case of Equation 6, when rendering images of the virtual cameras while changing the shape of the 3D elastic model, the 3D elastic model parameters d(nᵢ), Wᵢₖ, and λⱼᵢ are values determined when generating the 3D elastic model, and the elastic model parameters Rᵢ, tᵢ, and δᵢₜ representing the position change of the nodes related to the motion of the performer are calculated.

The apparatus for generating 3D content may determine the elastic model parameters Rᵢ, tᵢ, and δᵢₜ of the nodes in which the value of the cost function shown in Equation 6 is minimized while changing the elastic model parameters Rᵢ, tᵢ, and δᵢₜ in the 3D elastic model.

When the elastic model parameters Rᵢ, tᵢ, and δᵢₜ of each node determined in this way are applied to the 3D elastic model, a mesh model describing the performance of the performer is generated. This mesh model can be used as augmented reality content that can be rendered at any point in time.

In addition, if the method described above is applied to each performer in a performance hall, augmented reality contents of performance scenes in which several performer appear may be generated.

The apparatus for generating 3D content generates a 3D appearance model for each performer, generates a 3D elastic model for each performer, and calculates the position change parameter of each node for each performer by applying the cost function shown in Equation 6 to the images of the real cameras obtained from the actual performance to each performer. Next, by applying the position change parameters of each node for each performer to the 3D elastic model for each performer, the mesh model describing the performance of each performer may be generated. Furthermore, the 3D elastic model can be used to obtain 3D information by applying it not only to the body of the performer but also to props or clothes worn.

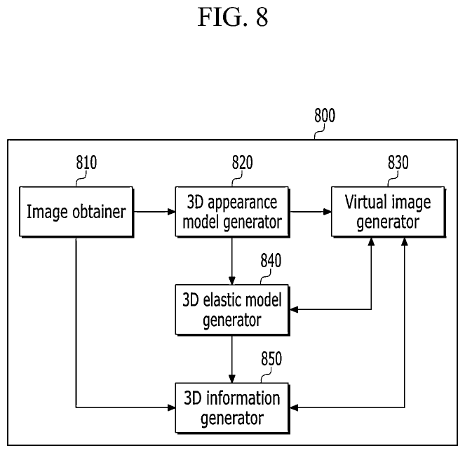

FIG. 8 is a diagram illustrating an apparatus for generating 3D content according to an embodiment.

Referring to FIG. 8, the apparatus for generating 3D content includes an image obtainer 810, a 3D appearance model generator 820, a virtual image generator 830, a 3D elastic model generator 840, and a 3D information generator 850.

The image obtainer 810 obtains a plurality of images photographed by a plurality of cameras installed at different positions in a predetermined space with respect to the fixed motion posture of the performer in the space. In addition, the image obtainer 810 obtains a plurality of images photographed by the plurality of cameras for any continuous motion postures of the performer. Furthermore, the image obtainer 810 obtains a plurality of images photographed by a plurality of cameras installed at different locations in the performance hall with respect to the actual performance scene of the performer.

The 3D appearance model generator 820 generates a 3D appearance model of the performer and texture information corresponding to each camera by using the plurality of images with respect to a fixed motion posture of the performer.

The virtual image generator 830 renders a plurality of virtual images photographed by a plurality of virtual cameras using the texture information. The plurality of virtual cameras photograph a 3D appearance model to which a 3D elastic model of each performer is applied, which changes according to values of 3D elastic model parameters necessary for generating a 3D elastic model. In addition, when performing the actual performance, when the plurality of virtual cameras photograph a 3D appearance model according to position change of each node in a 3D elastic model to which only 3D elastic model parameters related to the motion of the performer are applied to the previously generated 3D elastic model, the virtual image generator 830 renders a plurality of virtual images photographed by the plurality of virtual cameras using the texture information, during the actual performance.

The 3D elastic model generator 840 uniformly sets a plurality of nodes in the 3D appearance model of the performer, determines 3D elastic model parameters of each node by using a cost function in consideration of the color differences between a plurality of images photographed by the plurality of cameras for any continuous motion postures of the performer and rendered virtual images from a plurality of virtual images by the plurality of virtual cameras, and generates the 3D elastic model using the determined 3D elastic model parameters. The 3D elastic model generator 840 may determine the 3D elastic model parameters by using the cost function shown in Equation 5.

When performing the actual performance, the 3D information generator 850 determines 3D elastic model parameters of nodes representing the position change of the nodes related to the motion of the performer by using a cost function in consideration of the color differences between a plurality of images photographed by the plurality of cameras and rendered virtual images from a plurality of virtual images by the plurality of virtual cameras, with respect to the actual performance scene of the performer. A 3D appearance model according to a change of the 3D elastic model parameter values indicating position change of nodes in the 3D elastic model generated by 3D elastic model generator 840 is photographed through a plurality of virtual cameras, and a rendered virtual images for a plurality of virtual images photographed by the plurality of virtual cameras are used, in order to obtain 3D information about actual performance of the performer. When performing the actual performance, only the 3D elastic model parameters representing the position change of the nodes related to the motion of the performer needs to be calculated using the 3D elastic model generated by the 3D elastic model generator 840, so the 3D information generator 850 may determine values of 3D elastic model parameters representing position change of each node by using the cost function shown in Equation 6.

The 3D information generator 850 generates a mesh model describing the performance of the performer by applying values of a 3D elastic model parameters representing position change of each node to the 3D elastic model of the performer.

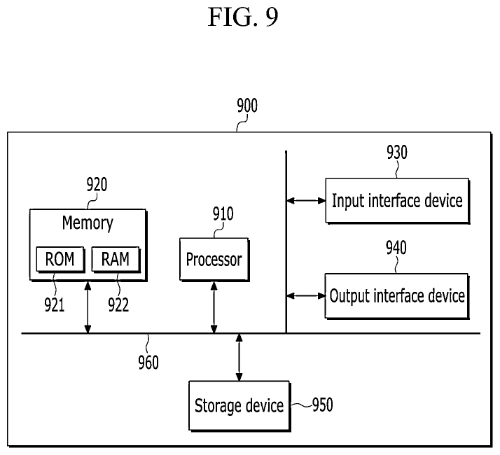

FIG. 9 is a diagram illustrating an apparatus for generating 3D content according to another embodiment.

Referring to FIG. 9, the apparatus for generating 3D content 900 may represent a computing device in which the method for generating 3D content described above is implemented.

The apparatus for generating 3D content 900 may include at least one of a processor 910, a memory 920, an input interface device 930, an output interface device 940, and a storage device 950. Each of the components may be connected by a common bus 960 to communicate with each other. In addition, each of the components may be connected through an individual interface or an individual bus centered on the processor 910 instead of the common bus 960.

The processor 910 may be implemented as various types such as an application processor (AP), a central processing unit (CPU), a graphics processing unit (GPU), etc., and may be any semiconductor device that executes a command stored in the memory 920 or the storage device 950. The processor 910 may execute a program command stored in at least one of the memory 920 and the storage device 950. The processor 910 may be configured to implement the method for generating 3D content described above with reference to FIGS. 1 to 8. For example, the processor 910 may load program commands for implementing at least some functions of the image obtainer 810, the 3D appearance model generator 820, the virtual image generator 830, the 3D elastic model generator 840, and the 3D information generator 850 described in FIG. 8 to the memory 920, and may perform the operations described with reference to FIGS. 1 to 8.

The memory 920 and the storage device 950 may include various types of volatile or non-volatile storage media. For example, the memory 920 may include a read-only memory (ROM) 921 and a random access memory (RAM) 922. In an embodiment, the memory 920 may be located inside or outside the processor 910, and the memory 920 may be connected to the processor 910 through various known means.

The input interface device 930 is configured to provide data to the processor 910.

The output interface device 940 is configured to output data from the processor 910.

In addition, at least some of the method for generating 3D content according to an embodiment may be implemented as a program or software executed in a computing device, and the program or software may be stored in a computer-readable medium.

In addition, at least some of the method for generating 3D content according to the embodiment may be implemented as hardware that can be electrically connected to the computing device.

According to an embodiment, it is possible to prevent deterioration of quality of the content due to the distance parameter between the performer and the camera without interfering with the performance activities of the performer.

The components described in the example embodiments may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the example embodiments may be implemented by software, and the software may be recorded on a recording medium. The components, functions, and processes described in the example embodiments may be implemented by a combination of hardware and software. The method according to example embodiments may be embodied as a program that is executable by a computer, and may be implemented as various recording media such as a magnetic storage medium, an optical reading medium, and a digital storage medium. Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network. Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic or magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., and magneto-optical media such as a floptical disk and a read only memory (ROM), a random access memory (RAM), a flash memory, an erasable programmable ROM (EPROM), and an electrically erasable programmable ROM (EEPROM), and any other known computer readable media. A processor and a memory may be supplemented by, or integrated into, a special purpose logic circuit. The processor may run an operating system (08) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media. The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination. Similarly, even though operations are described in a specific order in the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products. It should be understood that the embodiments disclosed herein are merely illustrative and are not intended to limit the scope of the invention. It will be apparent to one of ordinary skill in the art that various modifications of the embodiments may be made without departing from the spirit and scope of the claims and their equivalents.

What is claimed is:

1. A method for generating three-dimensional (3D) content for performance of a performer in an apparatus for generating 3D content, the method comprising:
obtaining a 3D appearance model and texture information of the performer using images of the performer located in the space;
setting a plurality of nodes in the 3D appearance model of the performer;
generating a 3D elastic model of the performer using the texture information;
obtaining a plurality of first images of a performance scene of the performer photographed by a plurality of first cameras installed in a performance hall;
rendering a plurality of virtual images obtained by photographing a 3D appearance model according to a position change of each node in a 3D elastic model of the performer through a plurality of first virtual cameras having the same intrinsic and extrinsic parameters as the plurality of first cameras, using the texture information;
determining an optimal position of each node by using color differences between the plurality of first images and the plurality of first rendered images obtained by the plurality of first virtual cameras; and
generating a mesh model describing the performance scene by applying 3D elastic model parameter values corresponding to the optimal position of each node to the 3D elastic model.

2. The method of claim 1, wherein the determining includes:
calculating values of a first cost function in consideration of color differences between the plurality of first images and the plurality of first rendered images while changing the 3D elastic model parameter values related to the position change of each node in the 3D elastic model; and
determining 3D elastic model parameter values of each node at which the value of the first cost function is minimized.

3. The method of claim 2, wherein the 3D elastic model parameter values related to a position change of each node includes translational and rotational parameters of each node.

4. The method of claim 1, wherein the generating of a 3D elastic model includes:
obtaining a plurality of second images of continuous motion postures of the performer photographed by a plurality of second cameras installed in the space;
rendering a plurality of virtual images obtained by photographing the 3D appearance model according to the change of the 3D elastic model parameter values required for generating the 3D elastic model of the performer through a plurality of second virtual cameras having the same intrinsic and extrinsic parameters as the plurality of second cameras, using the texture information; and
determining the 3D elastic model parameter values by using a second cost function in consideration of color differences between the plurality of second images and the plurality of second rendered images obtained by the plurality of second virtual cameras.

5. The method of claim 4, wherein the determining of the 3D elastic model parameter values includes:
calculating values of the second cost function while changing the 3D elastic model parameter values; and
determining the 3D elastic model parameter values at which the value of the second cost function is minimized.

6. The method of claim 4, wherein the 3D elastic model parameter values include a geodesic neighbor distance of each node, an elastic coefficient between each node and nodes within a geodesic neighbor distance of each node, parameters related to the position change of each node, and a physical property coefficient indicating the effect of the position change of each node on the change of each mesh vertex of the 3D appearance model.

7. The method of claim 1, wherein: the obtaining of a 3D appearance model and texture information includes generating the 3D appearance model of the performer and the texture information by using a plurality of images of the performer taking a fixed motion posture photographed by a plurality of second cameras installed in the space.

8. The method of claim 1, wherein the obtaining of a 3D appearance model and texture information includes generating the 3D appearance model and texture information of the performer through close-up photography of the performer using the plurality of second cameras in the space.

9. An apparatus for generating three-dimensional (3D) content for a performance of a performer, the apparatus comprising:
a 3D appearance model generator that generates a 3D appearance model and texture information using images of a performer located in a space;
a 3D elastic model generator that sets a plurality of nodes in the 3D appearance model and determines 3D elastic model parameter values for the plurality of nodes to generate a 3D elastic model of the performer;
an image obtainer that obtains a plurality of first images of the actual performance scene of the performer photographed by a plurality of first cameras installed in a performance hall;
a virtual image generator that renders a plurality of virtual images obtained by photographing a 3D appearance model according to a change of 3D elastic model parameter values related to the position change among the 3D elastic model parameter values through a plurality of first virtual cameras having the same intrinsic and extrinsic parameters as the plurality of first cameras, using the texture information; and
a 3D information generator that determines an optimal position of each node by using color differences between the plurality of first images and the plurality of first rendered images obtained by the plurality of first virtual cameras.

10. The apparatus of claim 9, wherein the 3D information generator generates a mesh model describing the performance scene of the performer by applying the 3D elastic model parameter values corresponding to the optimal position of each node to the 3D elastic model of the performer.

11. The apparatus of claim 9, wherein the 3D information generator calculates values of a first cost function in consideration the color differences between the plurality of first images and the plurality of first rendered images while changing the 3D elastic model parameter values related to the position change of each node in the 3D elastic model, and determines 3D elastic model parameter values of each node at which the value of the first cost function is minimized.

12. The apparatus of claim 9, wherein the image obtainer obtains a plurality of second images of continuous motion postures of the performer photographed by a plurality of second cameras installed in the space,
the virtual image generator renders a plurality of virtual images obtained by photographing the 3D appearance model according to the change of the 3D elastic model parameter values through a plurality of second virtual cameras having the same intrinsic and extrinsic parameters as the plurality of second cameras, using the texture information, and
the 3D elastic model generator determines the 3D elastic model parameter values by using a second cost function in consideration of color differences between the plurality of second images and the plurality of second rendered images obtained by the plurality of second virtual cameras.

13. The apparatus of claim 12, wherein the 3D elastic model generator calculates values of the second cost function while changing the 3D elastic model parameter values, and determines the 3D elastic model parameter values at which the value of the second cost function is minimized.

14. The apparatus of claim 12, wherein the 3D elastic model parameter values include a geodesic neighbor distance of each node, an elastic coefficient between each node and nodes within a geodesic neighbor distance of each node, parameters related to the position change of each node, and a physical property coefficient indicating the effect of the position change of each node on the change of each mesh vertex of the 3D appearance model.

15. The apparatus of claim 9, wherein the virtual image generator uses the remaining values excluding values related to the position change among the 3D elastic model parameter values as they are, when performing the actual performance by the performer.

16. The apparatus of claim 15, wherein the values related to the position change among the 3D elastic model parameter values include translational and rotational parameters of each node.

17. The apparatus of claim 9, wherein the image obtainer generates the 3D appearance model and texture information of the performer through close-up photography of the performer using the plurality of second cameras in the space.
